(19) United States
(12) Patent Application Publication
(10) Pub. No.: US 2012/0123872 A1
(43) Pub. Date: May 17, 2012

(54) COOPERATIVE PERSONALIZED PROMOTION METHOD ACCORDING TO CONSUMER-STORE INTERACTIVE TRANSACTION HISTORY AND SYSTEM USING THE SAME

(76) Inventors: Yi-Chia CHIU, Hsinchu City (TW); Ching-Hui Ho, Miaoli City (TW); Chen-Han Lee, Xizhi City (TW); Yu-Sheng Lin, Zhubei City (TW)

(21) Appl. No.: 13/178,269

(22) Filed: Jul. 7, 2011

(30) Foreign Application Priority Data
Nov. 16, 2010 (TW) 99139432

(51) Int. Cl. G06Q 30/00

(52) U.S. Cl. 705/14.67

(57) ABSTRACT

A system performs cooperative personalized promotion based on consumer-store interactive transaction history at multiple stores of different categories. The system includes a cooperative personal promotion platform. The cooperative personal promotion platform is provided for multiple stores of different categories to register a number of promotion information and to display at least one preferential-combination-information constituted by the promotion information. The promotion platform includes a data exchange interface, a remote-end server and a consumer record unit. The data exchange interface is used for reading a consumer's basic information into the platform, and connecting to the remote-end server via a network. The remote-end server is used for checking the consumer's basic information and recording consumer's latest interactive transaction in the consumer record unit for updating a consumer-store interactive transaction history. The cooperative personal promotion platform matches at least one preferential combination information for the consumer's choice according to the consumer-store interactive transaction history.

This application claims the benefit of Taiwan application Serial No. 99139432, filed Nov. 16, 2010, the subject matter of which is incorporated herein by reference.

### BACKGROUND

1. Technical Field

The disclosure relates in general to a promotion method and a system using the same, and more particularly to a cooperative personalized promotion method according to the interactive transaction history of at least one consumer at multiple stores of different categories and a system using the same.

2. Description of the Related Art

In a society with intensive business activities, measures of promotion are widely used to enhance the visibility of products and brands, and the intention of purchasement to consumers. However, promotion through conventional media channels, such as newspapers, magazines, broadcasting stations and TV, target at the general public of all age groups, social classes and genders, and rarely provide differential offers to individual consumer based on his/her preferences and/or attributes. There are various promotion measures, such as membership card, bonus card, provided by many department stores and franchise shops, which target at individual customers. However, these promotion measures are for stimulating customers' purchase and maintaining the relationships between the business and the customers so as to attract more customers, and are limited to be within single business system (such as the franchise shops or business groups). Moreover, most personalized promotion offers are presented after the event (after the consumer left the consumption point) when the customers are no more on the spot of consumption, and the stimulated impulse of consumption cannot be realized until the consumer return to the spot of consumption. Thus, the effects of promotion are reduced.

With the surge of Internet marketing and the rapid development of mobile communication, the consumer can be linked to the websites established by vendors via a mobile communication device or a computer to obtain the latest preferential information and promotion activities, and download the preferential information of promotion. To be granted the access to downloading the preferential information, a consumer normally has to obtain the membership of the website, go through a complicated login process and obtain a login credential. Moreover, most preferential information are limited to specific commodities or subjected to limited offers, and it is merely within the scope of a franchise or business group, rather than within a group of small business of different categories but in a near-by region. A travel destination with small business entities in different categories, such as cultural, lodging, cuisine, entertaining, may act as a virtual business group. This group can cooperatively provide personalized preferential offers by selecting offers from participating small business entities, based on tourists' personal consumption habits or attributes, and deliver the preferential offers to the tourists,while they are still on the trip in the travel destination region.

### SUMMARY

Accordingly, the disclosure is directed to a system performing cooperative personalized promotion based on consumer-store interactive transaction history at multiple stores of different categories. The system includes a cooperative personal promotion platform. The cooperative personal promotion platform is provided for multiple stores of different categories to register a number of promotion information and to display at least one preferential-combination-information constituted by the promotion information. The promotion platform includes a data exchange interface, a remote-end server and a consumer record unit. The data exchange interface is used for reading a consumer's basic information into the platform, and connecting to the remote-end server via a network. The remote-end server is used for checking the consumer's basic information. The consumer's latest interactive transaction is recorded in the consumer record unit for updating a consumer-store interactive transaction history. The cooperative personal promotion platform matches at least one preferential combination information for the consumer's choice according to the consumer-store interactive transaction history.

### BRIEF DESCRIPTION OF THE DRAWINGS

The disclosure can be more fully understand by reading the subsequent detailed description and examples with references made to the accompanying drawings, wherein:

FIGS. 1 and 2 are explanatory system structural diagrams for implementing a cooperative promotion method.

FIG. 3 is an explanatory flowchart of a cooperative personalized promotion method based on a consumer-store interactive transaction history at multiple stores of different categories according to an embodiment.

FIG. 4 is an explanatory system performing cooperative personalized promotion based on consumer-store interactive transaction history according to an embodiment.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

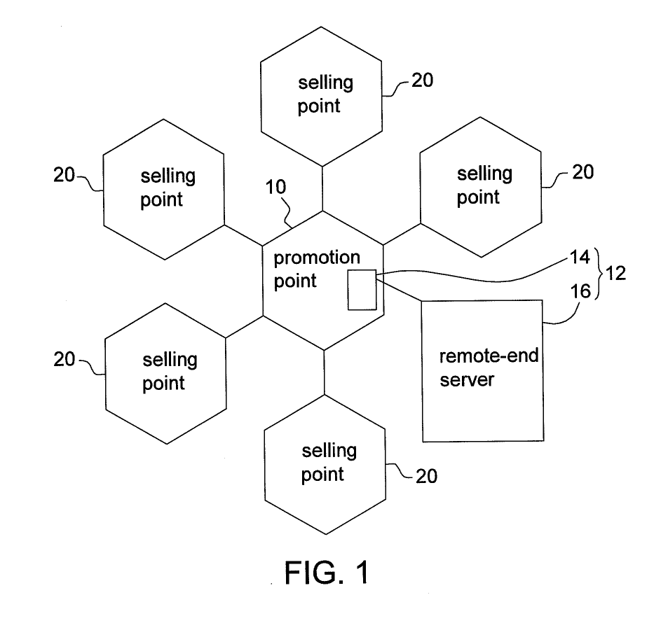

Referring to FIGS. 1 and 2, explanatory system structural diagrams for implementing a cooperative promotion method are shown. According to the cooperative personalized promotion method based on consumer-store interactive transaction history at multiple stores of different categories and the system using the same disclosed in the present embodiment, a cooperative personal promotion platform 12 is established at a promotion point 10, or a cooperative personal promotion platform 32 is established at a number of selling points 30. Referring to FIG. 1. The cooperative personal promotion platform 12 is established at the promotion point 10, such as a scenic spot, a visitor center, a rest area or a crowd gathering spot (such as a shopping mall or a transportation terminal). Since popular scenic spots and via places can all be used as a promotion point, the promotion point 10 of the present embodiment is not limited to any specific place. In FIG. 2, the data exchange interface 34 of the cooperative personal promotion platform 32 is directly disposed at each selling point 30 for forming a marketing network of cooperative promotion with other selling points 30 in the surrounding area. In the present embodiment, the cooperative personal promotion platform is established for a particular area of cooperative promotion, and there are multiple promotion points or/and selling points within this area. Each selling point sells/provides multiple commodities of different categories.

In FIG. 1, the promotion point 10 cooperatively promotes the commodities sold at each selling point 20 in the surrounding area. In FIG. 2, the commodities sold at each selling point 30 in the surrounding area are promoted cooperatively. Examples of the selling points 20 and 30 include playgrounds, monuments, restaurants, cafes, book shops, cinemas, souvenir shops. These shops can either belong to a profitable or a non-profitable organization, and the present embodiment does not specify any restriction. Based on the attributes of the commodities sold at the selling points 20 and 30, the categories of the commodities can be divided into souvenirs, gifts, accommodation vouchers, premium vouchers, discount vouchers, tickets, and so on. The categories of the commodities are not limited to the above exemplifications, and any commodities that can be traded at the selling points 20 and 30 can be used as an object of promotion.

In FIG. 1, the manager of each selling point 20 can login a data exchange interface 14 via an Internet network, a wireless broadband network or a mobile communication network, or directly logins a remote-end server 16, and records a promotion information or an updated promotion information in the remote-end server 16 for performing cooperative promotion, wherein the promotion information is commodity information or discount information. In FIG. 2, the manager of a selling point 30 can directly register a promotion information or update a latest promotion information in a subordinate data exchange interface 34, which transmits the registered or updated promotion information to the remote-end server 36 for cooperative promotion.

In FIGS. 1 and 2, a number of preferential-combination-information are constituted by the registered promotion information via cooperative promotion and displayed on the cooperative personal promotion platforms 12 and 32 for the consumer's choice. Besides, the manager of each of the selling points 20 and 30 can obtain the consumer's attributes and the used preferential-combination-information via the cooperative personal promotion platforms 12 and 32. The frequent use of a preferential-combination-information reflects its popularity. Provided that a certain preferential-combination-information is much more frequently used by female consumers, or a certain preferential-combination-information is much more frequently used by a particular age group, then the correlation between the consumer's attributes and the preferential-combination-information are determined, analyzed and recorded as a consumer-store interactive transaction which is further used as a basis for the cooperative promotion of the selling points 20 and 30.

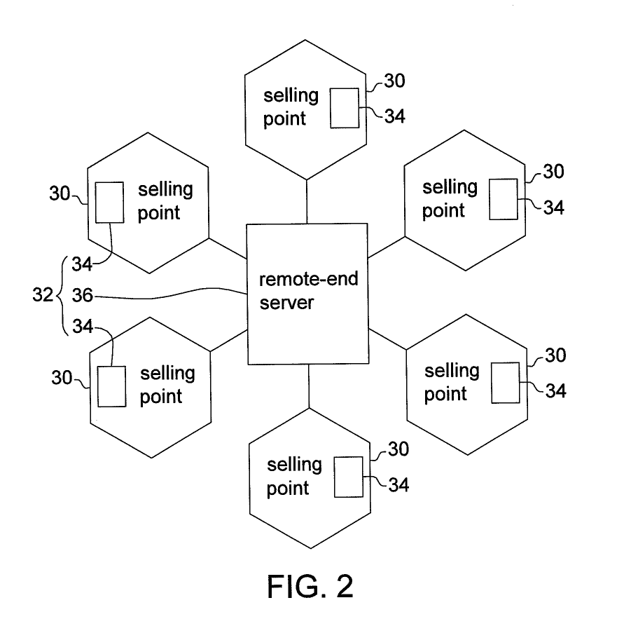

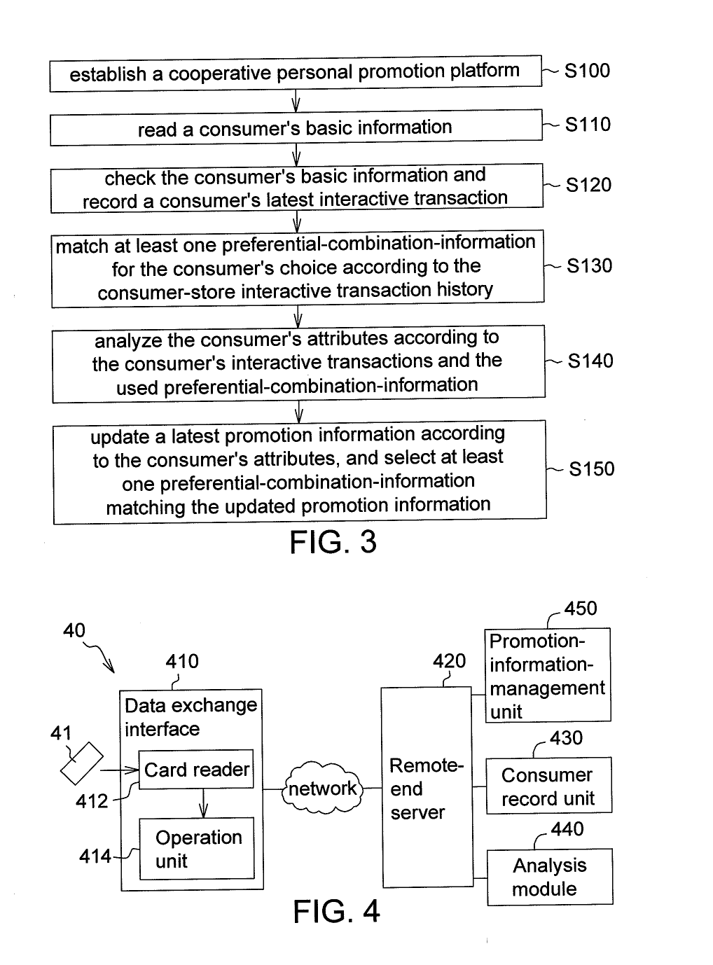

Referring to FIGS. 3 and 4. FIG. 3 shows a flowchart of a cooperative personalized promotion method based on a consumer-store interactive transaction history at multiple stores of different categories according to an embodiment. The method includes steps S100-S150. In the present embodiment, the transaction record conserved at the cooperative personal promotion platform includes the transactions such as the consumer purchases commodity at a particular store, obtains a preferential offer, uses the preferential offer or gives appraisal to a particular store. FIG. 4 shows a system performing cooperative personalized promotion based on consumer-store interactive transaction history at multiple stores of different categories according to an embodiment. As indicated in FIG. 4, the system includes a cooperative personal promotion platform 40. The cooperative personal promotion platform 40 includes a number of data exchange interfaces 410, a remote-end server 420 and a consumer record unit 430. The data exchange interfaces 410, such as disposed on a promotion point or a selling point, are used for reading a consumer's basic information into the platform and connecting to the remote-end server 420 via a network. The remote-end server 420 is used for checking the consumer's basic information and recording the consumer's latest interactive transaction at the store on the consumer record unit 430 for updating a consumer-store interactive transaction history.

The cooperative personalized promotion method based on consumer-store interactive transaction history of FIG. 3 is elaborated below with the system of FIG. 4 and the cooperative personal promotion platform 40 thereof.

Firstly, the method begins at step S100 as indicated in FIG. 3, a cooperative personal promotion platform 40 is established. The cooperative personal promotion platform 40 is provided for registering a number of promotion information and to display a number of preferential-combination-information constituted by the registered promotion information, wherein the promotion information includes commodity information or discount information. For example, the multiple preferential-combination-information can be constituted by the promotion information cooperatively promoted by shops, cafes and scenic spots in the surrounding area to replace the conventional promotion of promoting preferential voucher or distributing DM by individual store. The cooperative promotion enables the consumers to obtain the preferential-combination-information of multiple stores and identifies potential consumers through the analysis of consumer-store interactive transaction history so as to attract customers' attention, increase the promotion efficiency/effectiveness of multiple local stores and make potential consumers more likely to visit the stores and spend money there.

In step S110, a consumer's basic information is read into the platform, which includes name, sex distinction (male or female) and age etc., for example. In step S120, the consumer's basic information is checked, and the consumer's latest interactive transaction at the store is recorded. Referring to FIG. 4. In an embodiment, the consumer stores his/her basic information in an electronic card 41 which is further read by the data exchange interface 410. Examples of the electronic card 41 include smart cards, e-purses, financial cards, credit cards or other electronic cards 41 with identity recognition function capable of storing basic information for recognizing the consumer's identity. Examples of the basic information for recognizing the consumer's identity include card serial numbers, names, date of birth, gender, address and/or telephone numbers. When the consumer swipes the electronic card 41, the card reader 412 of the data exchange interface 410 reads the consumer's basic information, and further transmits the read data to a remote-end server 420 via a network. The remote-end server 420 compares the read data with the basic information stored in the consumer record unit 430 to confirm the consumer's identity.

In an embodiment, the remote-end server 420 records the consumer's latest interactive transaction at the store in the consumer record unit 430 for updating a consumer-store interactive transaction history. The login information contains the locations and store names of the selling points that a consumer has visited, and each selling point can give the consumer an incentive according to the number or frequency of visits. For example, if the consumer swipes cards for more than 10 times, then the cooperative personal promotion platform 40 can generate a transaction preferential information according to the latest interactive transaction (for example, the customer has paid more than 10 visits) for the consumer to obtain a voucher. The consumer can exchange the voucher for equivalent offer or gift at the store.

The interactive transaction refers to the content of consumption, the promotion interaction, store names and/or dates and so on that are recorded in the consumer record unit 430 after the consumer interacts with a selling point. Examples of the content of consumption include store names, amounts, product names and quantities. Examples of the promotion interaction include whether a preferential offer is obtained or used, and what products are inquired by customers. The types of consumers' favorite commodities and favorite selling points can be understood from the contents of the consumers' interactions with the selling points. For example, female consumers' favorite commodities are clothing, shoes, cosmetics, and after shopping, they may like to have afternoon tea at a nearby coffee shop, and then go to a nearby Karaoke or cinema. Likewise, male consumers also have their favorite commodities and consumption habits, and so do young consumers have their favorite commodities and consumption habits. Thus, each selling point can understand respective consumer group's favorite commodities and consumption habits via the cooperative promotion method, so as to efficiently provide different commodities or offers for different consumer groups at the promotion points or selling points of different categories.

When the consumer's basic information is checked, the cooperative personal promotion platform matches at least one preferential-combination-information for the consumer's choice according to the consumer-store interactive transaction history and records the result of choice for updating the consumer-store interactive transaction history in step S130. In an embodiment, the consumer is a 25 years old female for example, and the preferential-combination-information is a combination of the promotion information of an ABC fashion shop, a JKL café and an XYZ cinema. Referring to FIG. 4. In an embodiment, the data exchange interface 410 has an operation unit 414, which is a man-machine interface such as a touch screen, computer, and a mouse used for clicking the screen and keyboard to input data. The operation unit 414 displays preferential-combination-information, and records the preferential-combination-information selected by the consumer to the remote-end server 420 via a network. Besides, the remote-end server 420 further stores the preferential-combination-information selected by the consumer in the consumer record unit 430 for updating the consumer-store interactive transaction history. Thus, when the consumer swipes card or spend money at the selling points listed in the preferential-combination-information, the consumer can use the preferential offers cooperatively promoted by the selling points. In an embodiment, for example, the 25 female consumers selects preferential-combination-information of shopping at the ABC fashion shop and going to the XYZ cinema via the operation unit 414, then the remote-end server 420 stores the preferential-combination-information selected by consumer in the consumer record unit 430 for updating the consumer-store interactive transaction history. In an embodiment, the consumption habits of 20-30 years female customers can be inferred from the consumer-store interactive transaction history, and subsequently, the cooperative personal promotion platform can propose a preferential-combination-information of shopping at the ABC fashion shop and dining at the XYZ cinema for another 26 years old (among the range of 20˜30) female consumer. That is, personalized cooperative promotion of different categories can be performed according to the consumer-store interactive transaction history.

Thus, the cooperative personal promotion platform 40 of the present embodiment can perform cooperative promotion for multiple stores of different categories according to the consumption habits or attributes of individual or multiple consumers to provide personalized preferential-combination-information for the consumer's choice.

In another embodiment, given that the preferential-combination-information selected by the consumer is a frequently used preferential-combination-information, the cooperative personal promotion platform 40 matches the frequently used preferential-combination-information with first priority for the consumer's choice when the consumer logins or spends money next time. Moreover, given that the preferential-combination-information selected by the consumer is a used preferential-combination-information, the cooperative personal promotion platform 40 matches the used preferential-combination-information with first priority for the consumer's choice when the consumer logins or spends money next time. In addition, the cooperative personal promotion platform 40 can also combine the frequently used preferential-combination-information and the used preferential-combination-information, and then performs sorting and selects a number of top preferential-combination-information to form a new preferential-combination-information for the consumer's choice. That is, based on consumer-store interactive transaction history, personalized and presumably preferable promotion information is provided. For the consumers, they obtain their personalized and preferable promotion information. For the stores, they efficiently provide the promotion information to potential consumers not at random but in an efficient and effective manner.

In step S140, the consumer's attributes are analyzed according to the consumer's interactive, transactions and the used preferential-combination-information. Referring to FIG. 4. In an embodiment, the system further includes an analysis module 440 which is connected to the remote-end server 420. The analysis module 440 obtains the consumer-store interactive transaction history via the remote-end server 420 to understand the consumers' consumption habits and the used preferential-combination-information, and sorts the data and arranges various checking lists. The checking lists reflect the consumers' consumption habits or attributes, and useful business reports can be obtained through statistical analysis. For example, if the preferential-combination-information of the cooperative promotion does not catch the consumers' attention or interest, then the manager of a selling point can cancel the original preferential-combination-information, and re-design a preferential-combination-information that is more attractive to the consumers. Or, if the preferential-combination-information of the cooperative promotion is attractive to the consumers, then more similar preferential-combination-information can be presented to attract target customer groups. Thus, the consumers' consumption habits or attributes can be inferred from the analysis of the business report obtained by the analysis module 440, and can further be used as a basis for the cooperative promotion of each selling point.

In step S150, the latest commodity information is updated according to the consumer's attributes, and at least one preferential-combination-information matching the updated promotion information is selected. Referring to FIG. 4. In an embodiment, the system further includes a promotion-information-management unit 450 which is connected to the remote-end server 420. Like the consumers, the manager of each selling point can login the cooperative personal promotion platform 40 with an electronic card, or can be connected to the remote-end server 420 via their respective computer for setting or updating the promotion information stored in the promotion-information-management unit 450. If there is an updated promotion information to be presented, the manager of each selling point can analyze the business reports obtained from the analysis of the consumer-store interactive transaction history to obtain the latest information in relation to consumption, and further uses the latest information as a reference for selecting at least one preferential-combination-information matching the updated promotion information. Thus, the latest promotion information complying with the consumer attributes can be updated by the promotion-information-management unit 450 in a real-time manner, and the promotion efficiency/effectiveness can thus be increased.

In an embodiment, the selling point is such as the XYZ cinema, and the manager of the selling point, according to the business report information obtained from the promotion-information-management unit 450, understands that young female consumers visit the XYZ cinema more often than male customers. Bases on the business information that the ABC fashion shop is only 50 meters away from the XYZ cinema, the manager can promote a “movie plus free juice” offer targeting female consumers, and select to form a preferential combination with the ABC fashion shop. In the present embodiment, after the interactive transaction history is processed by the analysis module 440, various characteristics describing the various consumer-store interaction relationship disclosed above can be generated and used as a reference for matching the preferential-combination-information.

Let the activity of collecting the stamps in exchange for a souvenir that is commonly seen in a tourism area be taken for example. Conventionally, a stamp collection card is distributed to each tourist, who then goes to a certain number of stamping points to have his/her stamp collection card be stamped. After the tourist has collected a certain number of stamps on the stamp collection card, then the tourist goes to the visitor center to exchange the stamp collection card for a souvenir. In an embodiment, the above activity is conducted by the cooperative personal promotion platform 40, and the procedures of the activity are as follows: After a tourist arrives at a visitor center (a promotion point), the tourist interacts with the cooperative personal promotion platform 40 with an electronic card 41. The cooperative personal promotion platform 40 provides a first group of preferential-combination-information for the tourist's choice, and further records the tourist's choice in the consumer record unit 430 of the remote-end server 420 as an interactive transaction history. Then, the tourist uses the preferential offer at other selling point 30, the cooperative personal promotion platform 40 records the interactive transaction between the tourist and the store and provides a second group of preferential-combination-information for the tourist's choice, and further records the tourist's choice. The above procedures are repeated until the tourist's accumulated record of interactive transactions complies with a pre-determined condition (for example, the number of stamps on the stamp collection card reaches a pre-determined number), then the tourist can obtain a special preferential combination after the tourist interacts with the cooperative personal promotion platform at a promotion point or a selling point. In an embodiment, the tourist can go to a visitor center and exchange the stamp collecting card for a souvenir there, or the tourist can select personal preferred commodity or preferential offer among the promotion information provided by multiple stores.

A cooperative personalized promotion method based on consumer-store interactive transaction history at multiple stores of different categories and a system using the same are disclosed in above embodiments. According to the above embodiments, the cooperative promotion of the selling points in the surrounding area forms a cooperative promotion network, multiple preferential-combination-information are presented and displayed on a cooperative personal promotion platform for the consumer's choice, and the consumers' choices of preferential offers are recorded for analysis of consumers' needs. Thus, personalized promotion information are provided in response to personal consumption habits or attributes for increasing purchasement, enhancing the relationship between the stores and the consumers, establishing the association among multiple stores of different categories and promoting the sales of multiple stores. Meanwhile, local art/culture industry, tourism industry or food and drink industry are integrated, cooperative promotion channels of different categories are created, and localized service complying with personal consumption habits or attributes are provided.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A system performing cooperative personalized promotion based on consumer-store interactive transaction history at multiple stores of different categories, comprising:
a cooperative personal promotion platform provided for a plurality of stores of different categories to register a plurality of promotion information and to display at least one preferential-combination-information constituted by the promotion information,
wherein the cooperative personal promotion platform comprises a data exchange interface, a remote-end server and a consumer record unit, the data exchange interface is used for reading a consumer's basic information into the platform and connecting to the remote-end server via a network, the remote-end server is used for checking the consumer's basic information and recording a consumer's latest interactive transaction in the consumer record unit for updating a consumer-store interactive transaction history, and
the cooperative personal promotion platform matches at least one preferential-combination-information for the consumer's choice according to the consumer-store interactive transaction history.

2. The system according to claim 1, wherein the consumer stores the consumer's basic information in an electronic card for the data exchange interface to read from.

3. The system according to claim 1, further comprising an analysis module connected to the remote-end server, wherein the analysis module analyzes the consumer's attributes according to the consumer's interactive transactions and the used preferential-combination-information.

4. The system according to claim 1, further comprising a promotion-information-management unit connected to the remote-end server, wherein the promotion-information-management unit is used for setting or updating the promotion information.

5. The system according to claim 1, wherein the preferential-combination-information is constituted by the promotion information of the plurality of stores of different categories.

6. The system according to claim 1, wherein the promotion information comprises commodity information or discount information.

7. The system according to claim 1, wherein the consumer-store interactive transaction history conserves a record of interactive transactions between an individual consumer or/and other consumer and the multiple stores of different categories.

8. A cooperative personalized promotion method based on the consumer-store interactive transaction history at multiple stores of different categories according to the system of claim 1, wherein the method comprises:
establishing a cooperative personal promotion platform at a promotion point, wherein the promotion point promotes the commodities of the promotion information presented by the selling points of a plurality of stores of different categories in a surrounding area, and the cooperative personal promotion platform is provided for each selling point to register a promotion information and to display at least one preferential-combination-information constituted by the promotion information,
wherein the cooperative personal promotion platform comprises a data exchange interface, a remote-end server and a consumer record unit, the data exchange interface is used for reading a consumer's basic information into the platform and connecting to the remote-end server via a network, and the remote-end server is used for checking the consumer's basic information and recording a consumer's latest interactive transaction in the consumer record unit for updating a consumer-store interactive transaction history; and
matching at least one preferential-combination-information for the consumer's choice by the cooperative personal promotion platform according to the consumer-store interactive transaction history.

9. A cooperative personalized promotion method based on the consumer-store interactive transaction history at multiple stores of different categories according to the system of claim 1, wherein the method comprises:
establishing a cooperative personal promotion platform on selling points of a plurality of stores of different categories, wherein the cooperative personal promotion platform is provided for each selling point to register a promotion information and to display at least one preferential-combination-information constituted by the promotion information,
wherein the cooperative personal promotion platforms comprises a plurality of data exchange interfaces, a remote-end server and a consumer record unit, the data exchange interfaces are used for reading a consumer's basic information into the platform and connecting to the remote-end server via a network, the remote-end server is used for checking the consumer's basic information and recording a consumer's latest interactive transaction in the consumer record unit for updating a consumer-store interactive transaction history; and
matching at least one preferential-combination-information for the consumer's choice by the cooperative personal promotion platform according to the interactive transaction history.

10. A cooperative personalized promotion method based on the consumer-store interactive transaction history at multiple stores of different categories according to the system of claim 1, wherein the method comprises:
establishing a cooperative personal promotion platform, wherein the cooperative personal promotion platform is provided for a plurality of stores of different categories to register a plurality of promotion information and to display at least one preferential-combination-information constituted by the promotion information;
reading a consumer's basic information into the platform;
checking the consumer's basic information and recording a consumer's latest interactive transaction in the consumer record unit for updating a consumer-store interactive transaction history; and
matching at least one preferential-combination-information for the consumer's choice by the cooperative personal promotion platform according to the consumer-store interactive transaction history.

11. The method according to claim 10, wherein provided that the preferential-combination-information selected by the consumer is a frequently used preferential-combination-information, when the consumer makes transaction next time, the cooperative personal promotion platform matches the frequently used preferential-combination-information with first priority.

12. The method according to claim 10, wherein provided that the preferential-combination-information selected by the consumer is a used preferential-combination-information, when the consumer makes transaction next time, the cooperative personal promotion platform matches the used preferential-combination-information with first priority.

13. The method according to claim 10, further comprising analyzing the consumer's attributes according to the consumer's interactive transactions and the used preferential-combination-information.

14. The method according to claim 13, further comprising updating a latest promotion information according to the consumer's attributes and selecting at least one preferential-combination-information matching the updated promotion information.

15. The method according to claim 10, wherein the promotion information comprises commodity information or discount information.

16. The method according to claim 10, wherein the consumer-store interactive transaction history conserves a record of interactive transactions between an individual consumer or/and other consumer and the multiple stores of different categories.
